(19) United States
(12) Patent Application Publication
(10) Pub. No.: US 2026/0276276 A1
(43) Pub. Date: Sep. 17, 2026

(54) RELAY CONTROL APPARATUS, ELECTRICAL SYSTEM, RELAY CONTROL METHOD, APPARATUS, AND MEDIUM

(71) Applicants: GD MIDEA HEATING & VENTILATING EQUIPMENT CO., LTD., Foshan (CN); MIDEA GROUP CO., LTD., Foshan (CN)

(72) Inventors: Xinliang WANG, Foshan (CN); Yiyang MO, Foshan (CN); Xiaofan JIN, Foshan (CN)

(21) Appl. No.: 19/167,016

(22) PCT Filed: Feb. 4, 2024
(86) PCT No.: PCT/CN2024/075812

§ 371 Date: Sep. 19, 2025

(30) Foreign Application Priority Data
Mar. 27, 2023 (CN) 202310313076.9
Mar. 27, 2023 (CN) 202310313161.5

(51) Int. Cl. F25B 49/02; G05B 19/042

(52) U.S. Cl. CPC F25B 49/02; G05B 19/042; F25B 2500/222; G05B 2219/2654

(57) ABSTRACT

A relay control apparatus (100), an electrical system (1000), a relay control method, a relay control apparatus (20), and a storage medium (200). The relay control apparatus (100) includes a relay control board (10) configured to forward a control signal to an electrical appliance (300) to control an operating condition of the electrical appliance (300). The relay control board (10) selectively forwards the control signal according to a refrigerant leakage signal received when a refrigerant leaks to control the operating condition of the electrical appliance (300) associated with the refrigerant.

### CROSS-REFERENCE TO RELATED APPLICATIONS

This application claims priority to and benefits of Chinese patent application Nos. “202310313161.5” and “202310313076.9,” filed with China National Intellectual Property Administration on Mar. 27, 2023, the entire contents of which are incorporated herein by reference.

### FIELD

The present disclosure relates to the field of electrical appliance control technologies, and more particularly, to a relay control apparatus, an electrical system, a relay control method, a control apparatus, and a non-transitory computer-readable storage medium.

### BACKGROUND

In current electrical appliances, heating devices and heating devices are increasingly widely applied. With the development of the times, people have higher and higher requirements for environmental protection. Moreover, new environmentally friendly refrigerants that reduce ozone depletion and global warming are beginning to be used as refrigerants (such as R32) for refrigeration, but these new environmentally friendly refrigerants are highly flammable.

For an already mounted electrical appliance, if the new environmentally friendly refrigerant is to be used, a controller of the electrical appliance needs to be updated in response to potential safety hazards caused by the leakage of the new environmentally friendly refrigerant, to prevent this safety hazard, resulting in higher costs of using the new environmentally friendly refrigerant.

### SUMMARY

An objective of the present disclosure is to provide a relay control apparatus, an electrical system, a relay control method, an apparatus, and a medium, which are capable of selectively forwarding a control signal to be sent to an electrical appliance through a relay control board of a newly added relay control apparatus, controlling electrical appliance in response to a problem of refrigerant leakage, and preventing potential safety hazards caused by the refrigerant leakage.

A relay control apparatus is provided according to some embodiments of the present disclosure. The relay control apparatus includes a relay control board configured to forward a control signal to an electrical appliance to control an operating condition of the electrical appliance. The relay control board selectively forwards the control signal according to a refrigerant leakage signal received when a refrigerant leaks to control the operating condition of the electrical appliance associated with the refrigerant.

In some embodiments of the present disclosure, the relay control apparatus further includes a refrigerant detector configured to detect a concentration of the refrigerant in a current environment and send the refrigerant leakage signal to the relay control board when the concentration of the refrigerant is greater than a predetermined concentration.

In some embodiments of the present disclosure, the electrical appliance includes at least one of a heating device or a refrigeration device. The operating condition includes stopping operation. The control signal includes a heating signal and a refrigeration signal. The relay control board selectively forwards the heating signal and the refrigeration signal according to the refrigerant leakage signal, enabling the heating signal not to be received by the heating device associated with the refrigerant and the refrigeration signal not to be received by the refrigeration device associated with the refrigerant, to control the heating device and the refrigeration device to stop operating.

In some embodiments of the present disclosure, the relay control board includes a first refrigeration receiving interface, a first heating receiving interface, a first refrigeration forwarding interface, and a first heating forwarding interface. A controller that generates the control signal includes a first refrigeration sending interface and a first heating sending interface. The first refrigeration sending interface is configured to send the refrigeration signal to the first refrigeration receiving interface. The first heating sending interface is configured to send the heating signal to the first heating receiving interface. The refrigeration device includes a second refrigeration receiving interface. The heating device includes a second heating receiving interface. The first refrigeration forwarding interface is configured to forward the refrigeration signal to the second refrigeration receiving interface. The first heating forwarding interface is configured to forward the heating signal to the second heating receiving interface.

In some embodiments of the present disclosure, said controlling the heating device and the refrigeration device to stop operating includes: controlling the heating device to stop igniting and/or closing a gas valve of the heating device, and controlling a compressor of the refrigeration device to stop operating and/or closing a safety shut-off valve of the refrigeration device.

In some embodiments of the present disclosure, the electrical appliance includes a fan. The operating condition includes the operations of the fan at different gears that are directly proportional to wind force of the fan. The relay control board sends a gear control signal to the fan according to the refrigerant leakage signal to control the fan to operate at a predetermined gear.

In some embodiments of the present disclosure, the electrical appliance includes an outdoor unit connected to a controller that generates the control signal. The control signal sent by the controller directly reaches the outdoor unit to control an operating condition of the outdoor unit. The relay control board disconnects a power supply of the controller according to the refrigerant leakage signal, enabling the control signal not to be received by the indoor unit and the outdoor unit, to control the indoor unit and the outdoor unit to stop operating.

In some embodiments of the present disclosure, the relay control apparatus further includes a prompting device. The relay control board controls the prompting device to send prompting information according to the refrigerant leakage signal.

An electrical system is provided according to some embodiments of the present disclosure. The electrical system includes a controller, an electrical appliance, and the relay control apparatus according to any one of the above embodiments. The controller is configured to send a control signal. The electrical appliance is configured to operate according to the control signal.

A relay control method is provided according to some embodiments of the present disclosure. The relay control method includes: detecting a concentration of a refrigerant in a current environment; and selectively forwarding, when the concentration of the refrigerant is greater than a predetermined concentration, a control signal to an electrical appliance to control an operating condition of the electrical appliance associated with the refrigerant.

In some embodiments of the present disclosure, said selectively forwarding, when the concentration of the refrigerant is greater than the predetermined concentration, the control signal to the electrical appliance to control the operating condition of the electrical appliance associated with the refrigerant includes: controlling, when the concentration of the refrigerant is greater than the predetermined concentration, the electrical appliance associated with the refrigerant to enter a predetermined operating condition. The electrical appliance includes at least one of a refrigeration device, a heating device, or a fan.

In some embodiments of the present disclosure, said detecting the concentration of the refrigerant in the current environment includes: detecting infrared energy in a wave band corresponding to the refrigerant to determine the concentration of the refrigerant.

In some embodiments of the present disclosure, the electrical appliance includes the refrigeration device and the heating device. The predetermined operating condition includes stopping operation. Said controlling the electrical appliance associated with the refrigerant to enter the predetermined operating condition includes: controlling the refrigeration device and the heating device to stop operating.

In some embodiments of the present disclosure, said controlling the refrigeration device and the heating device to stop operating includes: stopping sending a refrigeration signal to the refrigeration device, and stopping sending a heating signal to the heating device.

In some embodiments of the present disclosure, when the refrigeration device fails to receive the refrigeration signal, a compressor of the refrigeration device stops operating, and/or a safety shut-off valve of the refrigeration device is closed. When the heating device fails to receive the heating signal, the heating device stops igniting, and/or a gas valve of the heating device is closed.

In some embodiments of the present disclosure, the refrigeration device performs refrigeration based on a refrigeration signal received from a temperature controller, and the heating device performs heating based on a heating signal received from the temperature controller. Said controlling the refrigeration device and the heating device to stop operating includes: disconnecting a power interface of the temperature controller.

In some embodiments of the present disclosure, the electrical appliance includes a fan, and the predetermined operating condition includes operating at a predetermined gear. Said controlling the electrical appliance associated with the refrigerant to enter the predetermined operating condition includes: controlling the fan to operate at the predetermined gear.

In some embodiments of the present disclosure, the relay control method includes: sending prompting information and entering a non-volatile lockout state when the concentration of the refrigerant is greater than the predetermined concentration.

A control apparatus is provided according to some embodiments of the present disclosure. The control apparatus includes a detection module and a control module. The detection module is configured to detect a concentration of a refrigerant in a current environment. The control module is configured to control, when the concentration of the refrigerant is greater than a predetermined concentration, an electrical appliance associated with the refrigerant to enter a predetermined operating condition. The electrical appliance includes at least one of a refrigeration device, a heating device, or a fan.

An electrical system is provided according to some embodiments of the present disclosure. The electrical system includes a refrigerant detector and a controller. The refrigerant detector is configured to detect a concentration of a refrigerant in a current environment. The controller is configured to control, when the concentration of the refrigerant is greater than a predetermined concentration, an electrical appliance associated with the refrigerant to enter a predetermined operating condition. The electrical appliance includes at least one of a refrigeration device, a heating device, or a fan.

A non-transitory computer-readable storage medium is provided according to the embodiments of the present disclosure. The computer program, when executed by a processor, causes the processor to perform the method according to any one of the above embodiments.

The relay control apparatus, the electrical system, the relay control method, the control apparatus, and the non-transitory computer-readable storage medium of the present disclosure selectively forward the control signal to be sent to the electrical appliance through the relay control board of the newly added relay control apparatus in the event of refrigerant leakage, controlling electrical appliance in response to the problem of refrigerant leakage. In this way, potential safety hazards caused by the refrigerant leakage can be prevented. Also, compared with higher costs of upgrading the controller of the electrical appliance, adding a relay control apparatus does not require upgrading the already mounted electrical appliance, which leads to lower costs of using new environmentally friendly refrigerants.

Additional aspects and advantages of embodiments of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic diagram showing connection of various components of an electrical system according to an embodiment.

FIG. 2 is a schematic diagram showing connection of various components of an electrical system according to another embodiment.

FIG. 3 is a schematic flowchart of a relay control method according to some embodiments of the present disclosure.

FIG. 4 is a schematic flowchart of a control method according to some embodiments of the present disclosure.

FIG. 5 is a schematic plan diagram of an electrical system according to some embodiments of the present disclosure.

FIG. 6 is a schematic flowchart of a control method according to some embodiments of the present disclosure.

FIG. 7 is a schematic flowchart of a control method according to some embodiments of the present disclosure.

FIG. 8 is a schematic flowchart of a control method according to some embodiments of the present disclosure.

FIG. 9 is a schematic flowchart of a control method according to some embodiments of the present disclosure.

FIG. 10 is a schematic flowchart of a control method according to some embodiments of the present disclosure.

FIG. 11 is a schematic flowchart of a control method according to some embodiments of the present disclosure.

FIG. 12 is a schematic diagram showing modules of a control apparatus according to some embodiments of the present disclosure.

FIG. 13 is a schematic diagram showing a connection state of a non-transitory computer-readable storage medium and a processor according to some embodiments of the present disclosure.

### DETAILED DESCRIPTION OF THE EMBODIMENTS

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the embodiments of the present disclosure.

In the present disclosure, unless expressly stipulated and defined otherwise, the first feature being “on” or “under” the second feature may mean that the first feature is in direct contact with the second feature, or the first and second features are in indirect contact through an intermediate. Moreover, the first feature being “on,” “above,” and “over” the second feature may mean that the first feature is directly above or obliquely above the second feature, or simply mean that the level of the first feature is higher than that of the second feature. The first feature being “under,” “beneath,” and “below” the second feature means that the first feature is directly below or obliquely below the second feature, or simply means that the level of the first feature is smaller than that of the second feature.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality” means at least two, unless otherwise specifically defined.

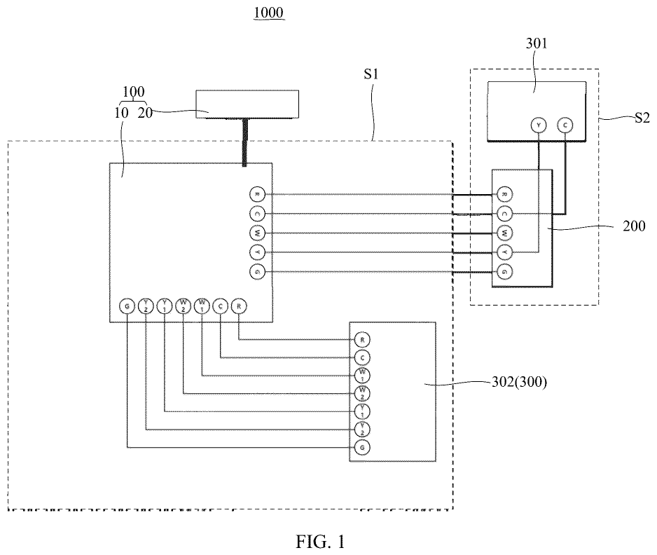

As illustrated in FIG. 1, a relay control apparatus 100 of the present disclosure includes a relay control board 10 configured to forward a control signal to an electrical appliance 300 to control an operating condition of the electrical appliance 300. The relay control board 10 selectively forwards the control signal according to a refrigerant leakage signal received when a refrigerant leaks to control the operating condition of the electrical appliance 300 associated with the refrigerant.

The relay control apparatus 100 of the present disclosure, in the event of refrigerant leakage, selectively forwards the control signal to be sent to the electrical appliance 300 through the relay control board 10 of the newly added relay control apparatus 100, controlling the electrical appliance 300 in response to the problem of refrigerant leakage. In this way, potential safety hazards caused by the refrigerant leakage can be prevented. Also, compared with higher costs of upgrading the controller 200 of the electrical appliance 300, adding a relay control apparatus 100 does not require upgrading the already mounted electrical appliance 300, which leads to lower costs of using new environmentally friendly refrigerants. Moreover, an exclusivity issue brought about by the communication protocol when the relay control apparatus 100 is connected can be avoided.

As illustrated in FIG. 1, an electrical system 1000 according to the embodiments of the present disclosure includes the controller 200, the electrical appliance 300, and the relay control apparatus 100. The controller 200 is configured to send a control signal, the relay control apparatus 100 is configured to forward the control signal to the electrical appliance 300, and the electrical appliance 300 operates according to the received control signal.

The controller 200 controls the operating condition of the electrical appliance 300 by sending the control signal. Each electrical appliance 300 has a corresponding controller 200, or a plurality of electrical appliances 300 are controlled by the same controller 200.

The electrical appliance 300 may include a refrigeration device 301 and a heating device 302. For the refrigeration device 301 and the heating device 302, the controller 200 may be a temperature controller, and the temperature controller may achieve temperature control by controlling the refrigeration device 301 and the heating device 302. The control signal may include a refrigeration signal to be sent to the refrigeration device 301 and a heating signal to be sent to the heating device 302. For example, during refrigeration, the controller 200 may send the refrigeration signal to the refrigeration device 301 to control the operation of the refrigeration device 301, and during heating, the controller 200 may send the heating signal to the heating device 302 to control the operation of the heating device 302.

The electrical appliance 300 associated with the refrigerant may be the electrical appliance 300 that uses the refrigerant or may ignite the refrigerant, such as the refrigeration device 301 and the heating device 302. The refrigeration device 301 (such as an air conditioner) may use a new environmentally friendly refrigerant for refrigeration. The new environmentally friendly refrigerant (such as R32 and 454b) is a new environmentally friendly refrigerant that does not contain element fluorine and thus have no destructive effect on ozone. However, the new environmentally friendly refrigerant is flammable. During a refrigeration process of the refrigeration device 301, if the new environmentally friendly refrigerant leaks, there are potential safety hazards due to its flammability. Also, during a heating process of the heating device 302 (such as a gas furnace), an open flame may be generated or ambient temperature may reach an ignition point of the new environmentally friendly refrigerant, causing the new environmentally friendly refrigerant to be ignited and triggering a fire. Therefore, to prevent the potential safety hazards caused by the refrigerant leakage, it is needed to control the operating conditions of the refrigeration device 301 and the heating device 302 when the refrigerant leaks.

The relay control apparatus 100 includes the relay control board 10 and a refrigerant detector 20. The relay control apparatus 100 is connected to both the controller 200 and the electrical appliance 300, and the relay control apparatus 100 is configured to selectively forward the control signal sent by the controller 200 to the electrical appliance 300. Specifically, the relay control board 10 selectively forwards the control signal from the controller 200 to the electrical appliance 300.

The relay control board 10 includes a first refrigeration receiving interface (a Y interface in the relay control board 10 as illustrated in FIG. 1), a first heating receiving interface (a W interface in the relay control board 10 as illustrated in FIG. 1), a first refrigeration forwarding interface (Y1 and Y2 interfaces in the relay control board 10 as illustrated in FIG. 1, and Y1 and Y2 may forward refrigeration signals of different gears), a first heating forwarding interface (W1 and W2 interfaces in the relay control board 10 as illustrated in FIG. 1, and W1 and W2 may forward heating signals of different gears), and a first power interface (R and C interfaces in the relay control board 10 as illustrated in FIG. 1). The first refrigeration receiving interface is configured to receive the refrigeration signal, the first heating receiving interface is configured to receive the heating signal, the first refrigeration forwarding interface is configured to forward the refrigeration signal to the refrigeration device 301, the first heating forwarding interface is configured to forward the heating signal to the heating device 302, and the first power interface is configured to supply power to the controller 200 to ensure normal operation of the controller 200.

The controller 200 includes a first refrigeration sending interface (a Y interface in the controller 200 as illustrated in FIG. 1), a first heating sending interface (a W interface in the controller 200 as illustrated in FIG. 1), and a second power interface (R and C interfaces in the controller 200 as illustrated in FIG. 1). The first refrigeration sending interface is configured to send the refrigeration signal, the first heating sending interface is configured to send the heating signal, and the second power interface is configured to connect to a power supply. The first refrigeration sending interface is connected to the first refrigeration receiving interface, the first heating sending interface is connected to the first heating receiving interface, and the first power interface is connected to the second power interface.

The refrigeration device 301 includes a second refrigeration receiving interface (a Y interface in the refrigeration device 301 as illustrated in FIG. 1), and the heating device 302 includes a second heating receiving interface (W1 and W2 interfaces in the heating device 302 as illustrated in FIG. 1). The second refrigeration receiving interface is configured to receive the refrigeration signal for refrigeration, and the second heating receiving interface is configured to receive the heating signal for heating. The first refrigeration forwarding interface is connected to the second refrigeration receiving interface, and the first heating forwarding interface is connected to the second heating receiving interface.

The controller 200 sends the refrigeration signal to the first refrigeration receiving interface through the first refrigeration sending interface, and then the first refrigeration forwarding interface forwards the refrigeration signal to the second refrigeration receiving interface, achieving refrigeration control of the refrigeration device 301. The controller 200 sends the heating signal to the first heating receiving interface through the first heating sending interface, and then the first heating forwarding interface forwards the heating signal to the second heating receiving interface, achieving heating control of the heating device 302.

For the refrigeration device 301, during the refrigeration, the controller 200 generally continuously sends the control signal (specifically, the refrigeration signal) to the refrigeration device 301. When the refrigeration device 301 does not receive the refrigeration signal, the refrigeration device 301 stops operating (that is, the operating condition include stopping operation). For the heating device 302, the controller 200 continuously sends the control signal (specifically, the heating signal) to the heating device 302 during heating. Similarly, when the heating device 302 does not receive the heating signal, the heating device 302 stops operating.

When the refrigeration device 301 and the heating device 302 operate normally, the relay control board 10 normally forwards the refrigeration signal and the heating signal. When the refrigerant leaks, the refrigeration device 301 needs to be controlled to stop operating, to prevent continuous leakage of the refrigerant during the operation of the refrigeration device 301, and it is also needed to control the heating device 302 to stop operating to prevent the refrigerant from being ignited during the operation of the heating device 302.

The refrigerant leakage can be determined by detecting a concentration of a refrigerant in a current environment through the refrigerant detector 20. If the concentration of the refrigerant is greater than a predetermined concentration, the refrigerant leakage is determined, and the refrigerant detector 20 may generate a refrigerant leakage signal when the refrigerant leakage, and send the refrigerant leakage signal to the relay control board 10. After receiving the refrigerant leakage signal, the relay control board 10 controls the operating condition of the electrical appliance 300 associated with the refrigerant. The refrigerant detector 20 may be disposed at the relay control board 10 and integrated with the relay control board 10 to form the relay control apparatus 100 for preventing the refrigerant leakage. This arrangement facilitates easy installation in any environment with a risk of the refrigerant leakage and avoid the exclusivity issue caused by the communication protocol.

To control the refrigeration device 301 and the heating device 302 to stop operating, the relay control board 10 simply needs to stop forwarding the received heating signal and refrigeration signal to the refrigeration device 301 and the heating device 302, respectively. In this case, neither the refrigeration device 301 nor the heating device 302 can receive the control signal, entering a stopping operation condition. In this way, the control signal is selectively forwarded by the relay control board 10 to indirectly control the refrigeration device 301 and the heating device 302.

The refrigeration device 301 may include a compressor and a safety shut-off valve. When the compressor operates, the refrigerant continuously flows, leaking from a damaged part of a pipeline. When the compressor stops operating, the refrigerant stops flowing, preventing more refrigerant from leaking. The safety shut-off valve is also disposed in the pipeline where the refrigerant flows. When the safety shut-off valve is closed, the refrigerant is unable to continue to flow, preventing more refrigerant from leaking. Therefore, controlling the refrigeration device 301 to stop operating may involve controlling the compressor of the refrigeration device 301 to stop operating and/or closing the safety shut-off valve of the refrigeration device 301, to prevent further leakage of the refrigerant.

The heating device 302 may include an ignition device and a gas valve. During the heating, the ignition device is required for ignition, and the ignition may cause the refrigerant leaked in the air to be ignited. When the gas valve is opened, the gas is ignited for combustion, and the open flame generated by gas combustion may also cause the refrigerant leaked in the air to be ignited. Therefore, controlling the heating device 302 to stop operating may involve controlling the heating device 302 to stop igniting and/or closing the gas valve, in such a manner that no open flame is generated, preventing the leaked refrigerant from being ignited. When the heating device 302 does not ignite the gas for the combustion, it is sufficient to simply stop the ignition. When the heating device 302 has ignited the gas for the combustion, it is needed to stop the ignition and close the gas valve to prevent the refrigerant from being ignited.

The electrical appliance 300 may include an indoor unit and an outdoor unit. For example, for an air conditioner in the refrigeration device 301, it includes an indoor air conditioner unit and an outdoor air conditioner unit. The indoor unit is mainly a device mounted indoors (such as a dashed box S1 in FIG. 1), and the outdoor unit is mainly a device mounted outdoors (such as a dashed box S2 in FIG. 1). The controller 200 may be disposed indoors or outdoors, which is not limited thereto.

Therefore, when the relay control board 10 is mounted, if the forwarding of the control signals for both the indoor unit and the outdoor unit is to be taken into account, wires are excessively long and wiring is complicated. If the relay control board 10 is mounted indoors, the forwarding of the control signal for the indoor unit can be realized. Generally, to avoid wire and wiring problems, the relay control board 10 may not forward the control signal for the outdoor unit. If the relay control board 10 is mounted outdoors, the forwarding of the control signal for the outdoor unit can be realized. Similarly, the relay control board 10 may not forward the control signal for the indoor unit. A situation where the relay control board 10 is mounted indoors is taken as an example for explanation below. A situation where the relay control board 10 is mounted outdoors is substantially similar, and thus details thereof will be omitted here.

The relay control board 10 selectively forwards the control signal to the indoor unit to control the operating condition of the indoor unit. For example, the indoor unit may be the heating device 302 (such as a gas furnace), a fan (not shown in the figure), etc.

For the gas furnace, it is needed to continuously receive the heating signal to maintain heating. Therefore, in the event of refrigerant leakage, the gas furnace can be stopped simply by no longer forwarding the heating signal to the gas furnace.

For the fan, the operating condition of the fan includes stopping operation and operation at different gears. When the refrigerant leaks, the fan needs to operate at a larger gear instead of stopping operation, to quickly transfer the refrigerant in the current environment to the outdoors, which reduces the concentration of the refrigerant in the current environment, avoiding the potential safety hazards caused by the refrigerant. Therefore, in the event of refrigerant leakage, the relay control board 10 needs to actively send a gear control signal to the fan to control the fan to operate at a predetermined gear, such as controlling the fan to operate at a maximum gear. It should be understood that, as the gear of the fan increases, wind force becomes greater and speed of reducing the concentration of the refrigerant in the environment also becomes faster. Therefore, operating the fan at its maximum gear can allow the concentration of the refrigerant in the environment to be reduced below the predetermined concentration in the shortest time.

In an embodiment, the fan is controlled by the gas furnace. Therefore, to achieve the control of the fan, it is only needed to control the heating device 302. For example, the gear control signal is sent to the gas furnace, and then the gas furnace controls the operating condition of the fan according to the gear control signal. To realize interface multiplexing, the gear control signal may be sent by a combination of a plurality of interfaces that have been set. For example, it can be jointly sent by the interfaces Y1 and Y2 in the relay control board 10. Alternatively, the relay control board 10 further includes a gear interface (such as a G interface in the relay control board in FIG. 1), and the gear control signal may be sent by the gear interface. Alternatively, the gear control signal may be jointly sent by interfaces Y1, Y2, and G in the relay control board 10. In this way, the number of wirings of the relay control board 10 can be reduced.

When the refrigerant leaks, it is also needed to control the compressor in the outdoor unit of the refrigeration device 301 to stop operating. Since the relay control board 10 cannot forward the refrigeration signal to the outdoor unit of the refrigeration device 301, the relay control board 10 is unable to control the compressor to stop operating by stopping the forwarding of the refrigeration signal. However, if the relay control board 10 supplies power to the controller 200 through the first power interface, the relay control board 10 can disconnect the first power interface and the second power interface, in such a manner that the controller 200 stops operating. When the controller 200 stops operating, the controller 200 no longer sends the control signal, to cause the electrical appliance 300 that needs to continuously receive the control signal to continuously operate to stop operating, thereby controlling the compressor to stop operating.

In this way, by disposing the relay control apparatus 100 indoors or outdoors, it is not only convenient for wiring and reduces the lines, but also can realize control of the operating condition of the electrical appliance 300 associated with the refrigerant, preventing the potential safety hazards caused by the refrigerant leakage.

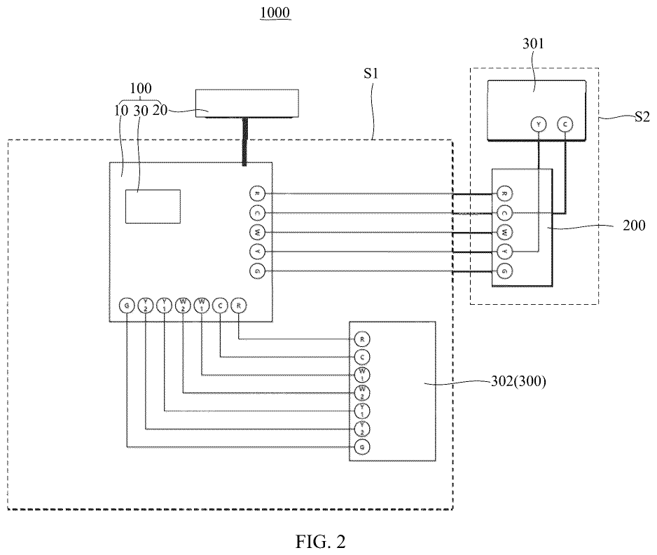

As illustrated in FIG. 2, the relay control apparatus 100 may further include a prompting device 30. When the relay control board 10 receives the refrigerant leakage signal, in addition to automatically controlling the operating condition of the electrical appliance 300 associated with the refrigerant, it may also send prompting information to prompt a user to deal with the refrigerant leakage in time, further preventing potential safety hazards caused by the refrigerant leakage.

For example, the prompting device 30 may include a loudspeaker. In the event of refrigerant leakage, the loudspeaker may emit a prompting sound, such as a beep or a buzz. The prompting device may also emit a prompting voice to remind the user of measures to deal with the refrigerant leakage. For example, the prompting voice is “please turn on the fan, and turn off the gas furnace and the air conditioner.” Alternatively, the prompting device 30 may include an indicator lamp, which may emit a prompting light, such as continuously emitting a red light and red flashing light, in the event of refrigerant leakage.

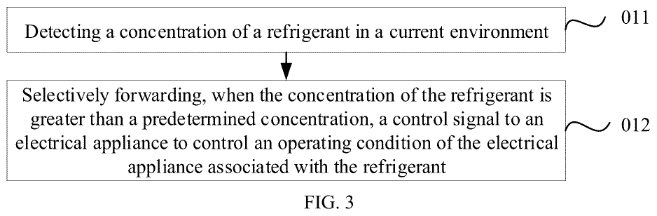

As illustrated in FIG. 1 and FIG. 3, a relay control method of the present disclosure includes operations at blocks 011 and 012.

At block 011, a concentration of a refrigerant in a current environment is detected.

At block 012, when the concentration of the refrigerant is greater than a predetermined concentration, a control signal is selectively forwarded to an electrical appliance 300 to control an operating condition of the electrical appliance 300 associated with the refrigerant.

Specifically, a refrigerant detector 20 may detect the concentration of the refrigerant in the current environment in real time. During operation of a refrigeration device 301, minor refrigerant leakage may occur. This leakage generally does not cause potential safety hazards, and will be quickly diluted with air flow. Only when the concentration of the refrigerant is greater than the predetermined concentration, it can be determined that the refrigerant in the current environment is not just a result of normal refrigerant leakage, but rather an indication of abnormal leakage due to damage to a refrigerant pipeline, etc. In this case, it can be determined that the refrigerant leakage has occurred and safety control is required. By selectively forwarding the control signal to the electrical appliance 300 associated with the refrigerant, the operating condition of the electrical appliance 300 is controlled, preventing further leakage of the refrigerant and the potential safety hazards caused by ignition of the refrigerant.

The relay control method of the present disclosure selectively forwards the control signal to be sent to the electrical appliance through a relay control board of a newly added relay control apparatus in the event of refrigerant leakage, controlling the electrical appliance in response to the problem of refrigerant leakage. In this way, the potential safety hazards caused by the refrigerant leakage can be prevented. Also, compared with higher costs of upgrading the controller of the electrical appliance, adding a relay control apparatus does not require upgrading the already mounted electrical appliance, which leads to lower costs of using new environmentally friendly refrigerants.

In some embodiments of the present disclosure, when the concentration of the refrigerant is greater than the predetermined concentration, the refrigeration signal to be sent to the refrigeration device 301 and the heating signal to be sent to the heating device 302 are no longer forwarded.

In this way, by stopping forwarding the refrigeration signal and the heating signal, the refrigeration device 301 and a heating device 302 can be controlled to stop operating.

In some embodiments of the present disclosure, when the concentration of the refrigerant is greater than the predetermined concentration, a first power interface of the relay control board 10 which is connected to a controller 200 is disconnected, to disconnect a power supply of the controller 200.

In this way, by disconnecting a power interface of the controller 200 and stopping the operation of the controller 200, the operation of the refrigeration device 301 and the heating device 302 is indirectly stopped.

In some embodiments of the present disclosure, when the concentration of the refrigerant is greater than the predetermined concentration, a gear control signal may be sent to a fan, to control the fan to operate at a predetermined gear.

In this way, the concentration of the refrigerant in the environment is reduced through blowing air by the fan.

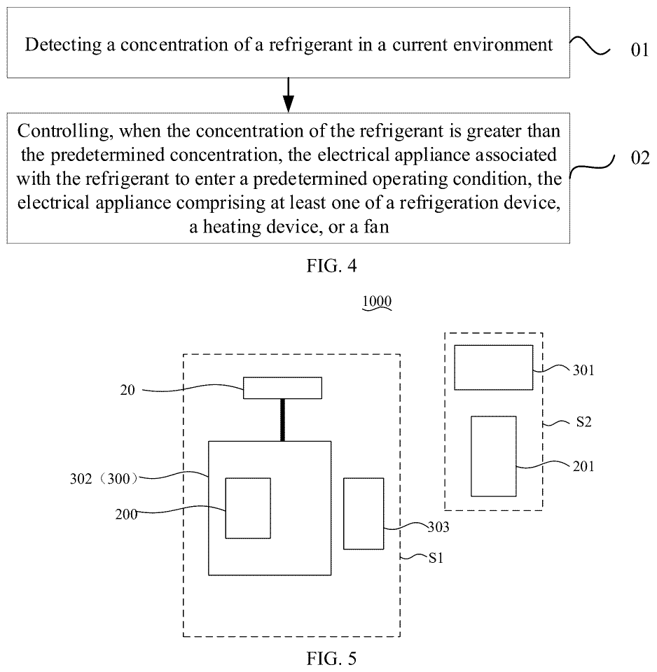

As illustrated in FIG. 4 and FIG. 5, a control method, provided in the embodiments of the present disclosure, includes operations at blocks 01 and 02.

At block 01, a concentration of a refrigerant in a current environment is detected.

Specifically, the refrigerant is a working fluid used in a refrigeration device (such as air conditioners) and other devices to transfer heat energy and produce a refrigeration effect. At present, the demand for household heating devices that also are equipped with refrigeration functions is becoming more and more widespread. With the development of the times, people have higher and higher requirements for environmental protection in recent years. Refrigeration devices have begun to use new environmentally friendly refrigerants that are more friendly to the environment, such as those that can reduce ozone depletion and are beneficial to improving a problem of global warming (such as R32 and 454b) as refrigerants. However, the new environmentally friendly refrigerants are highly flammable. Once they leak, they may cause fire problems, posing greater potential safety hazards. Therefore, the concentration of the refrigerant of the current environment can be detected in real time to promptly discover refrigerant leakage problems.

At block 02, when the concentration of the refrigerant is greater than the predetermined concentration, the electrical appliance 300 associated with the refrigerant is controlled to enter a predetermined operating condition. The electrical appliance 300 includes at least one of a refrigeration device 301, a heating device 302, or a fan 303.

Specifically, as illustrated in FIG. 5, the control method of the present disclosure may be applied to an electrical system 1000, which includes the electrical appliance 300 associated with the refrigerant. The electrical appliance 300 associated with the refrigerant may be a refrigeration device 301 that uses the refrigerant, or a heating device 302 that may ignite the refrigerant, or a fan 303 configured to reduce the concentration of the refrigerant in the current environment.

During normal operation of the refrigeration device 301, minor refrigerant leakage may occur. This leakage generally does not cause potential safety hazards, and will be quickly diluted with air flow. Only when the concentration of the refrigerant is greater than the predetermined concentration, it can be determined that the refrigerant in the current environment is not just a result of normal refrigerant leakage, but also an indication of abnormal leakage due to damage to the refrigerant pipeline, etc. In this case, it can be determined that the refrigerant leakage has occurred and safety control is required.

Therefore, a predetermined concentration may be set according to the concentration of the refrigerant in the environment. When it is detected that the concentration of the refrigerant in the current environment is greater than the predetermined concentration, the refrigerant leakage is determined. The electrical appliance 300 associated with the refrigerant is controlled to enter the predetermined operating condition. For example, the refrigeration device 301 and/or the heating device 302 are controlled to stop operating to prevent the operation of the refrigeration device 301 and the heating device 302 from igniting the refrigerant, or the fan 303 is controlled to start to reduce the concentration of the refrigerant in the current environment. In this way, the control of the electrical appliance 300 in response to the refrigerant leakage problem is achieved, preventing further leakage of the refrigerant, and avoiding the potential safety hazards caused by the refrigerant leakage.

The control method according to the embodiments of the present disclosure detects the concentration of the refrigerant in the current environment in real time to promptly find the refrigerant leakage problem. When the concentration of the refrigerant is greater than the predetermined concentration, the refrigerant leakage can be determined. In this case, in response to the refrigerant leakage problem, the electrical appliance 300 associated with the refrigerant is controlled to enter the predetermined operating condition. For example, the refrigerant device 301 and/or the heating device 302 are controlled to stop operating, and the fan 303 is controlled to operate to reduce the concentration of the refrigerant, to prevent further leakage of the refrigerant and avoid the potential safety hazards caused by the refrigerant leakage, making the electrical system 1000 safer and more reliable.

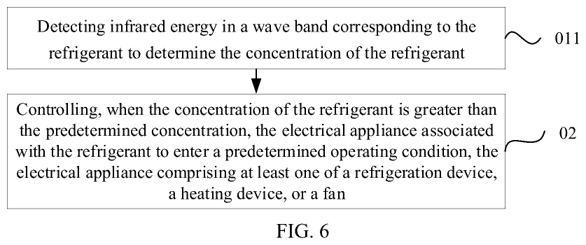

As illustrated in FIG. 6, in some embodiments of the present disclosure, the operation at block 01 of detecting the concentration of the refrigerant in the current environment includes an operation at block 011.

At block 011, infrared energy in a wave band corresponding to the refrigerant is detected to determine the concentration of the refrigerant.

Specifically, the electrical system 1000 further includes the refrigerant detector 20, which may be configured to detect the concentration of the refrigerant in the current environment. A core component of the refrigerant detector 20 includes an infrared absorption filter, which includes a transmitter and an infrared energy detector, with a sampling unit of the filter in between. The infrared energy is a part of an electromagnetic energy spectrum, and most materials can absorb infrared energy in specific and known wave bands. The specific wave band energy absorbed by the material is called absorption spectrum of that material. All refrigerants have similar absorption spectra ranging from 7.5 microns to 14 microns.

The transmitter can generate a high-intensity integrated infrared spectral energy flow containing all bands. When the high-intensity integrated infrared spectral energy flow passes through the filter, the filter blocks all infrared spectral energy flow outside the refrigerant absorption spectrum. The infrared spectral energy flow processed by the filter impacts the infrared energy detector, causing the infrared energy detector to heat up. When there is refrigerant leakage in the current environment, some infrared energy in the infrared spectral energy flow processed by the filter is absorbed by the refrigerant, resulting in a decrease in the infrared energy reaching the infrared energy detector, and accordingly, a decrease in the temperature of the infrared energy detector. In this way, the concentration of the refrigerant can be determined by detecting the infrared energy in the wave band corresponding to the refrigerant.

Further, in addition to using the refrigerant detector 20, there are other methods to determine whether the refrigerant leaks. For example, whether the refrigerant leaks may also be determined by detecting air pressure in the pipeline where the refrigerant is located. When the refrigerant does not leak, the air pressure in the pipeline where the refrigerant is located is a stable value. When the refrigerant leaks from the pipeline, the air pressure in the pipeline where the refrigerant is located suddenly drops. During the operation of the refrigeration device 301, minor refrigerant leakage may also occur. Therefore, when the drop in the air pressure in the pipeline where the refrigerant is located is small, it is considered that just a minor refrigerant leakage occurs during the normal operation of the refrigeration device 301, and there is no need to control the electrical appliance 300 associated with the refrigerant in this case. When the drop in the air pressure of the pipeline where the refrigerant is located is large, the refrigerant leakage can be determined. In this case, the electrical appliance 300 associated with the refrigerant needs to be controlled to enter the predetermined operating condition. Therefore, predetermined air pressure may also be set according to the air pressure in the corresponding pipeline where the refrigerant is located when the refrigerant leaks. When the air pressure in the pipeline where the refrigerant is located is smaller than the predetermined air pressure, the refrigerant leakage is determined, and the electrical appliance 300 associated with the refrigerant is controlled to enter the predetermined operating condition.

In this way, whether the refrigerant leaks can be determined by detecting the infrared energy in the wave band corresponding to the refrigerant, detecting the air pressure in the pipeline where the refrigerant is located, or other methods, to ensure that when the refrigerant leaks, the refrigerant leakage is detected in time and the electrical appliance 300 associated with the refrigerant is controlled to enter the predetermined operating condition, preventing further leakage of the refrigerant and avoiding the potential safety hazards caused by the refrigerant leakage.

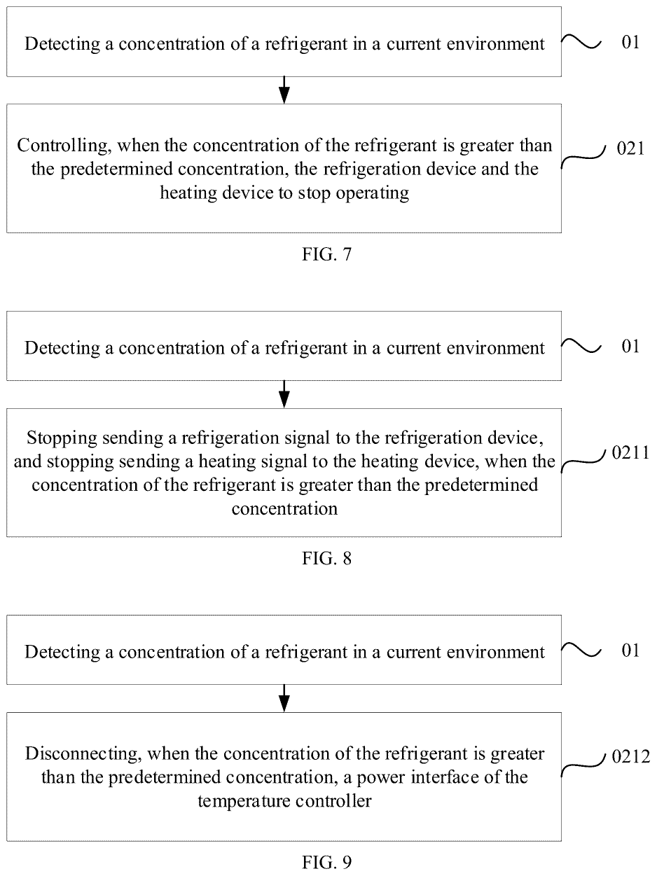

As illustrated in FIG. 5 and FIG. 7, in some embodiments of the present disclosure, the electrical appliance 300 includes the refrigeration device 301 and the heating device 302. The predetermined operating condition includes stopping operation. The operation at block 02 of controlling the electrical appliance associated with the refrigerant to enter the predetermined operating condition includes an operation at block 021.

At block 021, the refrigeration device 301 and the heating device 302 are controlled to stop operating.

Specifically, the refrigeration device 301 may use the new environmentally friendly refrigerant that is more friendly to the environment for refrigeration, such as using the new environmentally friendly refrigerant (such as R32 and 454b) as the refrigerant. However, the new environmentally friendly refrigerant is highly flammable. During a refrigeration process of the refrigeration device 301, if the new environmentally friendly refrigerant leaks, the refrigerant may be ignited. Also, during a heating process of the heating device 302 (such as a gas furnace), an open flame may be generated or ambient temperature may reach an ignition point of the new environmentally friendly refrigerant, causing the new environmentally friendly refrigerant to be ignited and triggering a fire. Therefore, when the concentration of the refrigerant is greater than the predetermined concentration, that is, when the refrigerant leaks, the refrigeration device 301 and the heating device 302 are controlled to stop operating, to avoid the potential safety hazards caused by the operation of the refrigeration device 301 and the heating device 302 when the refrigerant leaks.

As illustrated in FIG. 5 and FIG. 8, in some embodiments of the present disclosure, the operation at block 021 of controlling the refrigeration device and the heating device to stop operating may include an operation at block 0211.

At block 0211, a refrigeration signal is stopped from being sent to the refrigeration device 301, and a heating signal is stopped from being sent to the heating device 302.

Specifically, the electrical system 1000 further includes a controller 200. The controller 200 controls the operating condition of the electrical appliance 300 by sending the control signal. The control signal includes the refrigeration signal and the heating signal. When refrigeration is required, the controller 200 sends the refrigeration signal to the refrigeration device 301, and the refrigeration device 301 that receives the refrigeration signal starts to operate. When the refrigeration device 301 does not receive the refrigeration signal, the refrigeration device 301 stops operating. Similarly, when heating is required, the controller 200 sends the heating signal to the heating device 302, and the heating device 302 starts igniting. When the heating device 302 does not receive the heating signal, the heating device 302 also stops operating.

Therefore, when the heating device 302 and the refrigeration device 301 operate normally, the controller 200 continuously sends the control signal to the refrigeration device 301 and the heating device 302. When the refrigerant leaks, to prevent further leakage of the refrigerant, the refrigeration device 301 needs to be controlled to stop operating, and to prevent the leaked refrigerant from being ignited, the heating signal needs to be controlled to stop operating. Therefore, when the refrigerant leaks, simply stopping the controller 200 from sending the refrigeration signal to the refrigeration device 301 and the heating signal to the heating device 302 will cause the refrigeration device 301 and the heating device 302 to stop operating, preventing further leakage of the refrigerant and avoiding the potential safety hazards caused by the refrigerant leakage.

Further, one or more controllers 200 are provided. In an embodiment, each electrical appliance 300 has a corresponding controller 200. For example, each electrical appliance 300 includes an independent controller 200. In another embodiment, the plurality of electrical appliances 300 are controlled by the same controller 200. For example, the heating device 302 further includes a controller 200, which may be configured to send signals to the heating device 302 and the refrigeration device 301, to control the operating conditions of the heating device 302 and the refrigeration device 301, ensuring the normal operation of the refrigeration device 301 and the heating device 302, and facilitating the controller 200 to uniformly stop the operation of the heating device 302 and the refrigeration device 301 when the refrigerant leaks. In addition, using a single controller 200 to control a plurality of devices can also save mounting space of the electrical system 1000, making structural layout of the devices of the electrical system 1000 more compact.

Further, the electrical system 1000 may include an indoor unit and an outdoor unit. For example, for an air conditioner in the refrigeration device 301, it includes an indoor air conditioner unit and an outdoor air conditioner unit. The indoor unit is mainly a device mounted indoors (such as a dashed box S1 in FIG. 1), and the outdoor unit is mainly a device mounted outdoors (such as a dashed box S2 in FIG. 1). The controller 200 may be disposed indoors or outdoors, which is not limited thereto.

As illustrated in FIG. 5, in some embodiments of the present disclosure, when the refrigeration device 301 fails to receive the refrigeration signal, a compressor of the refrigeration device 301 stops operating, and/or a safety shut-off valve of the refrigeration device 301 is closed. When the heating device 302 fails to receive the heating signal, the heating device 302 stops igniting, and/or a gas valve of the heating device 302 is closed.

Specifically, the refrigeration device 301 may include the compressor and the safety shut-off valve. The compressor refrigerates by compressing the refrigerant, and the safety shut-off valve is disposed in the pipeline where the refrigerant is located to control the flow of the refrigerant. When the refrigeration device 301 requires refrigeration, it activates the compressor and opens the safety shut-off valve, allowing the refrigerant to continuously flow to the compressor. However, when the refrigerant leaks, it means that the pipeline where the refrigerant is located may be damaged. If the compressor continues to operate, the refrigerant continues to flow, causing more refrigerant to leak from the damaged part of the pipeline. Moreover, when the compressor operates, if the refrigerant is insufficient, it brings predetermined adverse effects to the compressor, such as overheating, thermal protection, or increased operation load of the compressor. In addition, sparks may occur when the compressor is started. If the compressor is started after the refrigerant leaks, there is a risk of igniting the refrigerant. Therefore, when the refrigerant leakage is detected, the controller 200 stops sending the refrigeration signal to the refrigeration device 301. When the refrigeration device 301 fails to receive the refrigeration signal, it can cause the compressor of the refrigeration device 301 to stop operating. This ensures that the compressor of the refrigeration device 301 stops operating and reduces damage to the compressor of the refrigeration device 301. Also, the safety shut-off valve of the refrigeration device 301 may be closed to ensure that the refrigerant in the pipeline where the refrigerant is located does not continue to flow, preventing further leakage of the refrigerant.

The heating device 302 may include an ignition device and a gas valve disposed in a pipeline where gas is located to control flow of the gas. When the heating is required, the heating device 302 opens the gas valve and the ignition device, allowing the ignition device to ignite the gas to implement the heating. However, if the refrigerant leaks while the heating device 302 operates, the ignition device may ignite the leaked refrigerant, and the open flame generated during combustion of the gas may ignite the leaked refrigerant. Moreover, the heat generated during the combustion of the gas may be dissipated to the surroundings. If the heat at a place near the heating device 302 is too high and the temperature thereof reaches the ignition point of the refrigerant, the refrigerant may also be ignited in this case. Therefore, when the refrigerant leakage is detected, the controller 200 also stops sending the heating signal to the heating device 302. When the heating device 302 fails to receive the heating signal, the heating device 302 stops igniting, and/or the gas valve of the heating device 302 is closed, to avoid generation of the open flame or a further increase in ambient temperature, preventing the leaked refrigerant from being ignited. When the heating device 302 does not ignite the gas for the combustion, only the ignition needs to be stopped. When the heating device 302 has ignited the gas for the combustion, it is needed to stop the ignition and close the gas valve to prevent the refrigerant from being ignited.

As illustrated in FIG. 5 and FIG. 9, in some embodiments of the present disclosure, the refrigeration device 301 performs refrigeration based on a refrigeration signal received from a temperature controller 201, and the heating device 302 performs heating based on a heating signal received from the temperature controller 201. The operation at block 021 of controlling the refrigeration device and the heating device to stop operating further includes an operation at block 0212.

At block 0212, a power interface of the temperature controller 201 is disconnected.

Specifically, the controller 200 may be a temperature controller 201, which can achieve temperature control by controlling the refrigeration device 301 and the heating device 302. For example, when refrigeration is needed, the temperature controller 201 sends the refrigeration signal to the refrigeration device 301 to allow the refrigeration device 301 to operate and reduce the temperature. When heating is needed, the temperature controller 201 sends the heating signal to the heating device 302 to allow the heating device 302 to operate and increase the temperature.

However, the refrigeration device 301 and the heating device 302 only continue to operate when the control signals are continuously received. Therefore, in the event of refrigerant leakage, the temperature controller 201 can be controlled to stop operating by disconnecting the power interface of the temperature controller 201. As a result, the temperature controller 201 cannot send the refrigeration signal to the refrigeration device 301 or the heating signal to the heating device 302, to cause the refrigeration device 301 and the heating device 302 to stop operating. In this way, further leakage of the refrigerant is prevented and the heating device 302 is prevented from igniting the refrigerant.

Further, the temperature controller 201 may be powered by a predetermined electrical appliance 300. For example, a power interface of the heating device 302 is connected to the power interface of the temperature controller 201, and the heating device 302 supplies power to the temperature controller 201. When the refrigerant leaks, the power interface of the temperature controller 201 is disconnected by the heating device 302. As a result, the temperature controller 201 will shut down and stop sending the refrigeration signal and the heating signal, indirectly controlling the stop of refrigeration and heating.

In other embodiments, the controller 200 includes the temperature controller 201 and the controller 200 of the heating device 302. The temperature controller 200 is configured send the refrigeration signal to control the operation of the refrigeration device 301. The controller 200 of the heating device 302 is configured to send the heating signal to control the operation of the heating device. When the refrigerant leaks, the refrigeration device 301 is controlled to stop operating by the temperature controller 201, and the heating device is controlled to stop operating by the controller 200 of the heating device 302. Specifically, if the power interface of the heating device 302 is connected to the power interface of the temperature controller 201 at this time, the controller 200 of the heating device 302 can, on the one hand, control the heating device 302 to stop operating by stopping sending the heating signal to the heating device 302, and on the one hand, can also control the refrigeration device 301 to stop operating by disconnecting the power interface of the temperature controller 201.

In this way, the operation and stop of the refrigeration device 301 and the heating device 302 can be controlled by the controller 200, ensuring that the refrigeration device 301 and the heating device 302 can be stopped in time when the refrigerant leaks, and preventing accidents.

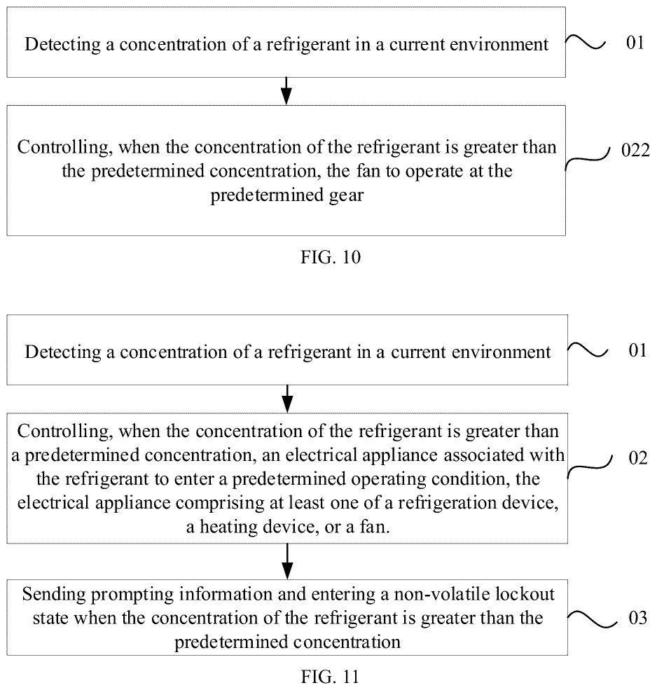

As illustrated in FIG. 5 and FIG. 10, in some embodiments of the present disclosure, the electrical appliance 300 includes a fan 303, and the predetermined operating condition includes operating at a predetermined gear. The operation at block 02 of controlling the electrical appliance 300 associated with the refrigerant to enter the predetermined operating condition further includes an operation at block 022.

At block 022, the fan 303 is controlled to operate at the predetermined gear.

Specifically, the electrical appliance 300 further includes the fan 303 configured to dilute concentration of leaked refrigerant in the air. The fan 303 may be an electrical appliance 300 separately disposed in the electrical system 1000, and may be disposed in the electrical appliance 300 associated with the refrigerant. For example, the heating device 302 may include the fan 303, and the refrigeration device 301 may also include the fan 303. The fan 303 may operate at different gears. When the refrigerant leaks, the fan 303 needs to operate at a larger gear to accelerate a rate of diluting the concentration of the leaked refrigerant, reducing the concentration of the refrigerant, and preventing the potential safety hazards caused by the leaked refrigerant. Therefore, the predetermined operating condition of the fan 303 includes operating at the predetermined gear, and the predetermined gear is a larger gear. When the refrigerant leakage is detected, the controller 200 sends a gear control signal to the fan 303 to control the fan 303 to operate at the predetermined gear. For example, the fan 303 is controlled to operate at a maximum gear. It should be understood that, as the gear of the fan 303 increases, wind force becomes greater and speed of reducing the concentration of the refrigerant in the environment also becomes faster. Therefore, operating the fan 303 at its maximum gear allows the concentration of the refrigerant in the environment to be reduced below the predetermined concentration in the shortest time.

Further, the concentration of the refrigerant in the current environment can be detected in real time, and the gear of the fan 303 can be adjusted according to the concentration of the refrigerant. For example, when a high concentration of the refrigerant is detected, the fan 303 is controlled to operate at its maximum gear, to increase the rate of diluting the concentration of the leaked refrigerant as much as possible. When the concentration of the refrigerant is low, the fan 303 is controlled to operate at a smaller gear, to reduce power consumption during the operation of the fan 303.

As illustrated FIG. 11, in some embodiments of the present disclosure, the control method further includes an operation at block 03.

At block 03, prompting information is sent and a non-volatile lockout state is entered when the concentration of the refrigerant is greater than the predetermined concentration.

Specifically, when the refrigerant leakage is detected, in addition to controlling the electrical appliance 300 associated with the refrigerant to enter the predetermined operating condition, the electrical system 1000 may also send the prompting information to prompt the user to deal with the refrigerant leakage in time, avoiding the potential safety hazards caused by the refrigerant leakage. In this case, the electrical system 1000 may also enter the non-volatile lockout state, which is a safe shutdown state of the electrical system 1000. In this state, restarting can only be achieved through manual reset by the user, to ensure that the refrigeration device 301 and the heating device 302 are not be automatically restarted. The refrigeration device 301 and the heating device 302 are only restarted after the user determines that the refrigerant leakage problem has been resolved, ensuring that no further refrigerant leakage occurs before the problem is solved and further preventing the potential safety hazards caused by the refrigerant leakage.

For example, the electrical system 1000 may include a loudspeaker. In the event of refrigerant leakage, the loudspeaker may emit a prompting sound, such as a beep or a buzz. The prompting device may also emit a prompting voice to remind the user of measures to deal with the refrigerant leakage. For example, the prompting voice is “please turn on the fan, and turn off the gas furnace and the air conditioner.” Alternatively, the electrical system 1000 may include an indicator lamp, which may emit a prompting light, such as continuously emitting a red light and red flashing light, in the event of refrigerant leakage.

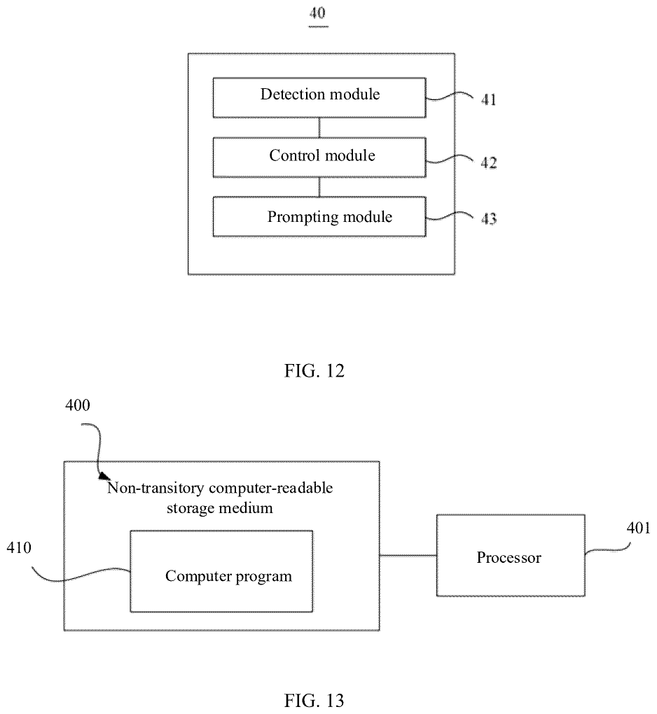

As illustrated in FIG. 12, to facilitate better implementation of the control method according to the embodiments of the present disclosure, the embodiments of the present disclosure further provide a control apparatus 40. The control apparatus 40 may include a detection module 41 and a control module 42. The detection module 41 is configured to detect a concentration of a refrigerant in a current environment. The control module 42 is configured to control, when the concentration of the refrigerant is greater than a predetermined concentration, an electrical appliance 300 associated with the refrigerant to enter a predetermined operating condition. The electrical appliance 300 includes at least one of a refrigeration device 301, a heating device 302, or a fan 303.

The detection module 41 is specifically configured to detect infrared energy in a wave band corresponding to the refrigerant to determine the concentration of the refrigerant.

The control module 42 is specifically configured to control the refrigeration device 301 and the heating device 302 to stop operating.

The control module 42 is specifically configured to stop sending a refrigeration signal to the refrigeration device 301 and stop sending a heating signal to the heating device 302.

The control module 42 is specifically configured to disconnect a power interface of the temperature controller 201.

The control module 42 is specifically configured to control the fan 303 to operate at the predetermined gear.

The control apparatus 40 may also include a prompting module 43 configured to send prompting information and enter a non-volatile lockout state when the concentration of the refrigerant is greater than the predetermined concentration.

As illustrated in FIG. 5, the embodiments of the present disclosure further provide an electrical system 1000. The electrical system 1000 includes a refrigerant detector 20 and a controller 200. The refrigerant detector 20 is configured to detect a concentration of a refrigerant in a current environment. The controller 200 is configured to detect a concentration of a refrigerant in a current environment, and control, when the concentration of the refrigerant is greater than a predetermined concentration, the electrical appliance 300 associated with the refrigerant to enter a predetermined operating condition. The electrical appliance300 includes at least one of a refrigeration device 301, a heating device 302, or a fan 303.

Optionally, the controller 200 may also execute the control method according to any one of the above embodiments. Details thereof will be omitted here for simplicity.

As illustrated in FIG. 13, the embodiments of the present disclosure further provide a non-transitory computer-readable storage medium 400 having a computer program 410 stored thereon. The computer program 410, when executed by a processor 401 (e.g., the above controller 200), to implement the method according to any one of the above embodiments. Details thereof will be omitted here for simplicity.

It should be understood that, the computer program 310 includes computer program codes that may be in a source code form, an object code form, an executable file, an intermediate form, or the like. The computer-readable storage medium may include any entity or device capable of carrying computer program codes, a recording medium, a USB flash drive, a removable hard disk, a diskette, an optical disk, a computer memory, a read-only memory (ROM), a random access memory (RAM), a software distribution medium, or the like.

In the description of this specification, descriptions with reference to the terms “an embodiment,” “some embodiments,” “illustrative embodiments,” “examples,” “specific examples” “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, different embodiments or examples and features of different embodiments or examples described in the specification may be combined by those skilled in the art without mutual contradiction.

Any process or method described in a flowchart or described herein in other ways may be understood to include one or more modules, segments, or portions of codes of executable instructions for achieving specific logical functions or steps in the process. The scope of a preferred embodiment of the present disclosure includes other implementations. A function may be performed not in a sequence shown or discussed, including a substantially simultaneous manner or a reverse sequence based on the function involved, which should be understood by those skilled in the art to which the embodiments of the present disclosure belong.

Although embodiments of the present disclosure have been illustrated and described above, it should be understood that the above embodiments are merely exemplary, and cannot be construed to limit the present disclosure. For those skilled in the art, changes, alternatives, and modifications can be made to the embodiments without departing from the scope of the present disclosure.

1.-21. (canceled)

22. A relay control apparatus comprising:
a relay control board configured to selectively forward a control signal to an electrical appliance according to a refrigerant leakage signal associated with a refrigerant to control an operating condition of the electrical appliance associated with the refrigerant, the refrigerant leakage signal being generated in response to leakage of the refrigerant.

23. The relay control apparatus according to claim 22, further comprising:
a refrigerant detector configured to detect a concentration of the refrigerant in a current environment and send the refrigerant leakage signal to the relay control board in response to the concentration of the refrigerant being greater than a predetermined concentration.

24. The relay control apparatus according to claim 22, wherein:
the electrical appliance includes at least one of a heating device or a refrigeration device, the operating condition includes stopping operation, and the control signal includes at least one of a heating signal or a refrigeration signal; and
the relay control board is configured to selectively forward the at least one of the heating signal or the refrigeration signal according to the refrigerant leakage signal, enabling the at least one of the heating signal or the refrigeration signal not to be received by the at least one of the heating device associated with the refrigerant or the refrigeration device associated with the refrigerant, to control the at least one of the heating device or the refrigeration device to stop operating.

25. The relay control apparatus according to claim 24, wherein:
the relay control board includes a first refrigeration receiving interface, a first heating receiving interface, a refrigeration forwarding interface, and a heating forwarding interface;
a controller that generates the control signal includes a first refrigeration sending interface and a first heating sending interface, the first refrigeration sending interface being configured to send the refrigeration signal to the first refrigeration receiving interface, and the first heating sending interface being configured to send the heating signal to the first heating receiving interface; and
the refrigeration device includes a second refrigeration receiving interface, and the heating device includes a second heating receiving interface, the refrigeration forwarding interface being configured to forward the refrigeration signal to the second refrigeration receiving interface, and the heating forwarding interface being configured to forward the heating signal to the second heating receiving interface.

26. The relay control apparatus according to claim 24, wherein controlling the at least one of the heating device or the refrigeration device to stop operating includes at least one of:
controlling the heating device to stop igniting and/or closing a gas valve of the heating device, or
controlling a compressor of the refrigeration device to stop operating and/or closing a safety shut-off valve of the refrigeration device.

27. The relay control apparatus according to claim 22, wherein:
the electrical appliance includes a fan, and the operating condition includes operations of the fan at different gears that are directly proportional to wind force of the fan; and
the relay control board is configured to send a gear control signal to the fan according to the refrigerant leakage signal to control the fan to operate at a predetermined one of the different gears.

28. The relay control apparatus according to claim 22, wherein:
the electrical appliance includes an indoor unit and an outdoor unit connected to a controller that generates the control signal, the control signal sent by the controller directly reaching the outdoor unit to control an operating condition of the outdoor unit;
the relay control board is configured to disconnect a power supply of the controller according to the refrigerant leakage signal, enabling the control signal not to be received by the indoor unit and the outdoor unit, to control the indoor unit and the outdoor unit to stop operating.

29. The relay control apparatus according to claim 22, further comprising:
a prompting device;
wherein the relay control board is further configured to control the prompting device to send prompting information according to the refrigerant leakage signal.

30. An electrical system comprising:
a controller configured to send a control signal;
an electrical appliance configured to operate according to the control signal; and
the relay control apparatus according to claim 22.

31. A relay control method comprising:
detecting a concentration of a refrigerant in a current environment; and
selectively forwarding, in response to the concentration of the refrigerant being greater than a predetermined concentration, a control signal to an electrical appliance to control an operating condition of the electrical appliance associated with the refrigerant.

32. The relay control method according to claim 31, wherein selectively forwarding the control signal includes:
controlling the electrical appliance associated with the refrigerant to enter a predetermined operating condition, the electrical appliance including at least one of a refrigeration device, a heating device, or a fan.

33. The relay control method according to claim 31, wherein detecting the concentration of the refrigerant includes:
detecting infrared energy in a wave band corresponding to the refrigerant to determine the concentration of the refrigerant.

34. The relay control method according to claim 31, wherein:
the electrical appliance includes at least one of a refrigeration device or a heating device, and the predetermined operating condition includes stopping operation, and
controlling the electrical appliance associated with the refrigerant to enter the predetermined operating condition includes:
controlling the at least one of the refrigeration device or the heating device to stop operating.

35. The relay control method according to claim 34, wherein controlling the at least one of the refrigeration device or the heating device to stop operating includes at least one of:
stopping sending a refrigeration signal to the refrigeration device; or
stopping sending a heating signal to the heating device.

36. The relay control method according to claim 35, wherein:
when the refrigeration device fails to receive the refrigeration signal, a compressor of the refrigeration device stops operating, and/or a safety shut-off valve of the refrigeration device is closed; and
when the heating device fails to receive the heating signal, the heating device stops igniting, and/or a gas valve of the heating device is closed.

37. The relay control method according to claim 34, wherein:
the refrigeration device is configured to perform refrigeration based on the refrigeration signal received from a temperature controller, and the heating device is configured to perform heating based on the heating signal received from the temperature controller; and
controlling the at least one of the refrigeration device or the heating device to stop operating includes:
disconnecting a power interface of the temperature controller.

38. The relay control method according to claim 31, wherein:
the electrical appliance includes a fan, and the predetermined operating condition includes operating at a predetermined gear; and
controlling the electrical appliance to enter the predetermined operating condition includes:
controlling the fan to operate at the predetermined gear.

39. The relay control method according to claim 31, further comprising:
sending prompting information and entering a non-volatile lockout state in response to the concentration of the refrigerant being greater than the predetermined concentration.

40. An electrical system comprising:
a refrigerant detector configured to detect a concentration of a refrigerant in a current environment; and
a controller configured to execute the relay control method according to claim 31.

41. A non-transitory computer-readable storage medium storing a computer program that, when executed by a processor, causes the processor to perform the method according to claim 31.
